(19) United States
(12) Patent Application Publication
(10) Pub. No.: US 2015/0324324 A1
(43) Pub. Date: Nov. 12, 2015

(54) Linear Regression Using Safe Screening Techniques

(71) Applicant: SAS Institute Inc., Cary, NC (US)

(72) Inventors: Jun Liu, Cary, NC (US); Zheng Zhao, Cary, NC (US)

(21) Appl. No.: 14/571,224

(22) Filed: Dec. 15, 2014

Related U.S. Application Data
(60) Provisional application No. 61/994,580, filed on May 16, 2014.
(60) Provisional application No. 61/990,090, filed on May 7, 2014.

(51) Int. Cl. G06F 17/10

(52) U.S. Cl. CPC G06F 17/10

(57) ABSTRACT

Systems and methods for linear regression using safe screening techniques. A computing system may receive, from a user of the system, a data set including a set of variables, the set of variables being related to a linear model for predicting a response variable of the data set. The computing system may determine an active set of variables using a safe screening algorithm The computing system may generate the linear model using the active set and a least angle regression algorithm. The computing system may provide, to the user of the system, information related to the linear model.

### CROSS-REFERENCE TO RELATED APPLICATIONS

The present disclosure claims priority to U.S. Provisional Application No. 61/994,580, filed May 16, 2014 and titled “Efficient LARS-LASSO Via SASVI Techniques,” and U.S. Provisional Application No. 61/990,090, filed May 7, 2014 and titled “LARS-LASSO via SASVI,” the entirety of each of which are incorporated herein by reference.

### TECHNICAL FIELD

The present disclosure generally relates to computer-implemented systems and methods for linear regression using safe screening techniques.

### BACKGROUND

Many users use predictive modeling to analyze high dimensional data in various applications. Currently, various model selection algorithms exist for obtaining a piecewise constant solution path for high dimension data sets. But, these algorithms can be computationally expensive. Additionally, current attempts at improving the efficiency of the model selection algorithm require a series of pre-defined parameters.

### SUMMARY

In accordance with the teachings provided herein, systems and methods for constructing linear regression models using safe screening techniques.

For example a computer-program product tangibly embodied in a non-transitory machine-readable storage medium is provided that includes instructions that can cause a data processing apparatus to receive, from a user of the computer-program product, information associated with a data set, the data set including a set of variables, the set of variables being related to a linear model for predicting a response variable of the data set. The instructions can further cause the data processing apparatus to determine an active set of variables using a safe screening algorithm, the active set of variables being a subset of the set of variables included in the data set that are determined to be below a threshold degree of relevance for predicting the response variable. The instructions can further cause the data processing apparatus to generate the linear model using the active set and a least angle regression algorithm including a least squares regression algorithm, the least squares regression algorithm constraining a number of absolute regression coefficients utilized in the least angle regression algorithm. The instructions can further cause the data processing apparatus to provide, to the user of the computer-program product, information related to the linear model.

In another example, a computer-implemented method is provided that includes receiving, from a user of a computing device, a data set including a set of variables, the set of variables being related to a linear model for predicting a response variable of the data set. The method further includes determining, by the computing device, an active set of variables using a safe screening algorithm, the active set of variables being a subset of the set of variables included in the data set, the active set excluding variables from the data set that are determined to be below a threshold degree of relevance for predicting the response variable. The method further includes generating, by the computing device, the linear model using the active set and a least angle regression algorithm, the least angle regression including a least squares regression algorithm, the least squares regression algorithm constraining a number of absolute regression coefficients utilized in the least angle regression algorithm. The method further includes providing, to the user of the computing device, information related to the linear model.

In another example, a system is provided that includes a processor and a non-transitory computer readable storage medium containing instructions that, when executed on the processor, cause the processor to perform operations. The operations include receiving, from a user of the system, a data set including a set of variables, the set of variables being related to a linear model for predicting a response variable of the data set. The operations further include determining an active set of variables using a safe screening algorithm, the active set of variables being a subset of the set of variables included in the data set, the active set excluding variables from the data set that are determined to be below a threshold degree of relevance for predicting the response variable. The operations further include generating the linear model using the active set and a least angle regression algorithm, the least angle regression including a least squares regression algorithm, the least squares regression algorithm constraining a number of absolute regression coefficients utilized in the least angle regression algorithm. The operations further include providing, to the user of the system, information related to the linear model.

### BRIEF DESCRIPTION OF THE DRAWINGS

FIG. 1 illustrates a block diagram of an example of a computer-implemented environment for generating a linear model.

FIG. 2 illustrates a block diagram of an example of a processing system of FIG. 1 for generating one or more linear models for a data set.

FIG. 3 illustrates an example of a process for applying a Least Angle Regression (LARS) Least Absolute Shrinkage and Selection Operator (LASSO) algorithm to a data set.

FIG. 4 illustrates an example of a flow diagram for generating, by a model generation engine, a linear model for the data set using a LARS-LASSO algorithm.

FIG. 5 illustrates an example of a process for applying a LARS-LASSO algorithm to a reduced data set determined using a Safe Screening via Variational Inequalities (SASVI) safe screening technique.

FIG. 6 illustrates an example of a flow diagram for determining and updating an active data set using a SASVI safe screening technique.

FIG. 7 illustrates an example of a flow diagram for generating a linear model.

FIG. 8 illustrates an example of a flow diagram for determining an active set.

FIG. 9 illustrates an example of a flow diagram for updating an active set for the data set.

FIG. 10 illustrates an example of an algorithm for generating synthetic data for testing the efficiency of linear model generator.

FIG. 11 illustrates an example of an algorithm for generating synthetic data for testing the efficiency of linear model generator.

Like reference numbers and designations in the various drawings indicate like elements.

### DETAILED DESCRIPTION

Certain aspects of the disclosed subject matter relate to systems and associated techniques for a linear regression using safe screening techniques. An example linear regression algorithm includes the LARS-LASSO algorithm. An example safe screening technique includes the SASVI algorithm. The LARS-LASSO algorithm is used for obtaining a solution to LASSO without requiring pre-specified regularization parameters. Regularization parameters are used for model selection to prevent over-fitting by penalizing models with extreme parameter values. Existing safe screening techniques require a series of regularization parameters that are determined in advance. Current aspects of the disclosed subject matter relate to applying a safe screening technique that avoids the necessity for pre-specified regularization parameters. Safe screening techniques according to some examples can improve the overall performance of the LARS-LASSO algorithm.

For example, many commonly used methods for data mining, machine learning, and statistical modeling use a regression algorithm to determine a predictive model for a data set. The disclosed subject matter can improve the overall performance of the regression algorithm by reducing the number of variables on which to conduct the regression analysis. Safe screening techniques can be used as the mechanism for reducing the number of variables in a data set to a smaller active set on which to determine the predictive model.

Model selection algorithms are a form of regression algorithms and are directed to identifying a subset of relevant features for use in model construction. The assumption in model selection algorithms is that the data set contains many redundant or irrelevant variables. Redundant variables are those that provide no more information than other variables in the data set, and irrelevant variables provide no useful information in any context. By reducing the data set to a subset of relevant, non-redundant variables, model selection algorithms may improve model interpretability, provide shorter training times, and enhance generalization by reducing over-fitting.

Many model selection methods (e.g., LASSO) may perform model selection by optimizing a penalized convex optimization problem associated with the data set. A model selection algorithm can utilize a least squares regression algorithm for which a number of absolute regression coefficients are constrained. For example, using regularization parameters, LASSO imposes a penalty to the sum of the absolute values of the regression coefficients so that increasing the penalty can cause more of the parameters in the data set to be driven towards zero. Once determined to be under a threshold, these variables can be discarded. LASSO is useful, in some contexts, due to its tendency to prefer solutions with fewer non-zero parameter values, effectively reducing the number of variables upon which the given solution is dependent.

LARS is a model selection algorithm that implements LASSO. The LARS algorithm can calculate possible LASSO estimates for a given problem using an order of magnitude less computing time than other methods. LARS relates to a model-selection method known as “Forward Selection” where, given a collection of possible predictor variables, a number of variables are selected having the largest absolute correlations with a response y. Forward selection involves starting with no variables in a model and testing the addition of each variable using a chosen model comparison criteria, add the variable if the variable improves the model the most in a set of variables, and repeating this process until no variable exists that improves the model. A predictor variable may be selected and simple linear regression of y on the selected predictor variable is performed. This leaves a residual vector orthogonal to the selected predictor variable. The other predictor variables are projected to the residual in order to select the predictor variable with the highest correlation to response y, and the process is repeated. After k operations, this results in a set of predictor variables that are used in to construct a k-parameter linear model. At each operation, LARS-LASSO adds a variable if the correlation between variable and response is deemed higher than a threshold value, or drops a variable if the correlation is deemed lower than the threshold value. In another example, a variable may be added in the case where the variable has not previously been in the model, but has been determined to have a magnitude of correlation above a threshold amount. In yet a further example, a variable may be dropped from the model if the coefficient of the variable begin to change sign (e.g., from positive to negative, or from negative to positive). In such a manner, a solution path of LASSO can be obtained. Each operation of LARS-LASSO can involve the evaluation of the correlations between the variables and the residual, which can be computationally expensive, especially in the case of a large number of variables.

In other words, the LARS procedure may begin with all coefficients equal to zero and finds a predictor, x₁, that is most correlated with the response. The algorithm then determines the largest step possible in the direction of this predictor, executes the operations, and repeats this process until some other predictor x₂ has as much correlation with the current residual. LARS then proceeds in a direction equiangular between the two predictors, repetitively determining a largest step and taking the step, until a third variable, x₃, earns its way into the “most correlated” set. LARS then proceed in an equiangular manner between x₁, x₂, and x₃, along the least angle direction (the direction that maintains equal angles between the direction traversed and x₁, x₂, and x₃, respectively) until a fourth variable enters, and so on. By taking operations in the least angle direction between multiple variables, LARS allows the correlations of the multiple variables to the response to be considered equally. Safe screening techniques can identify and discard the variables that are guaranteed to have zero coefficients in the model. Since a larger number of irrelevant or redundant variables can be discarded with safe screening, the LASSO computation can be significantly accelerated.

Certain aspects of the disclosed subject matter relate to providing an effective scheme to prevent the requirement of the pre-specified regularization parameter by the usage of the feature sure removal parameter. Systems and methods according to some examples can compute the safe screening regularization parameter, which can help prevent the requirement of a pre-specified regularization parameter.

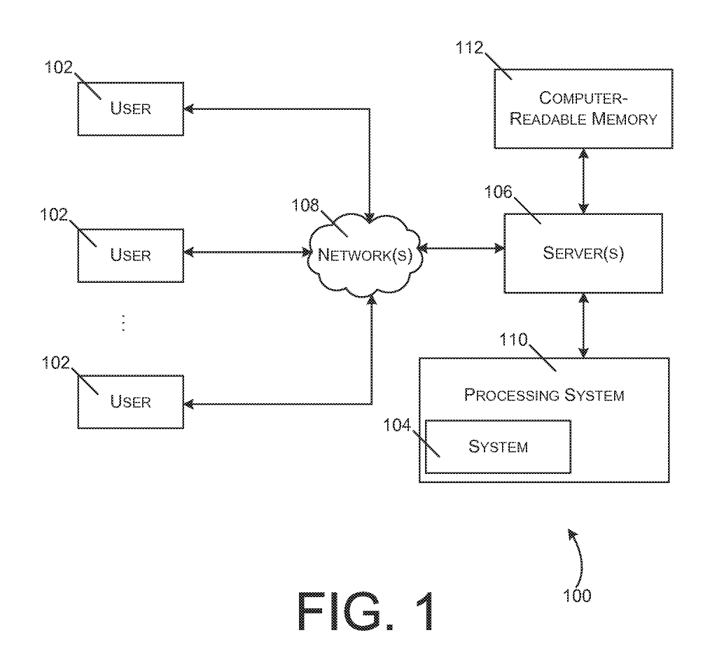

FIG. 1 illustrates a block diagram of an example of a computer-implemented environment 100 for generating a number of graphs related to a data set. Users 102 can interact with a system 104 hosted on one or more servers 106 through one or more networks 108. The system 104 can contain software operations or routines. The users 102 can interact with the system 104 through a number of ways, such as over networks 108. Servers 106, accessible through the networks 108, can host system 104. The system 104 can also be provided on a stand-alone computer for access by a user.

In one example, the environment 100 may include a stand-alone computer architecture where a processing system 110 (e.g., one or more computer processors) includes the system 104 being executed on it. The processing system 110 has access to a computer-readable memory 112.

In one example, the environment 100 may include a client-server architecture.

Users 102 may utilize a PC to access servers 106 running a system 104 on a processing system 110 via networks 108. The servers 106 may access a computer-readable memory 112.

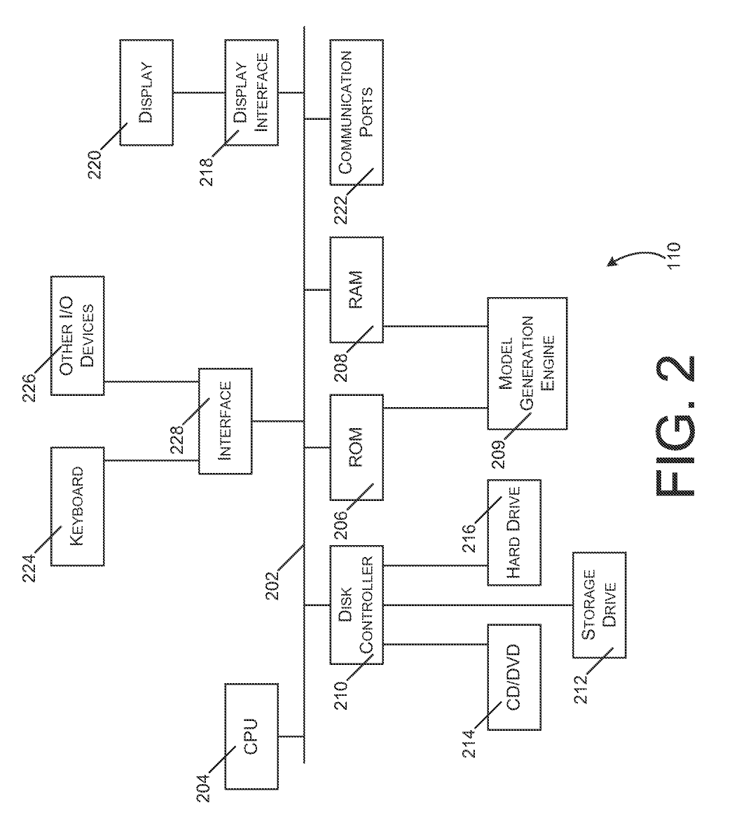

FIG. 2 illustrates a block diagram of an example of a processing system of FIG. 1 for generating one or more linear models for a data set. A bus 202 may interconnect the other illustrated components of processing system 110. Central processing unit (CPU) 204 (e.g., one or more computer processors) may perform calculations and logic operations used to execute a program. A processor-readable storage medium, such as read-only memory (ROM) 206 and random access memory (RAM) 208, may be in communication with the CPU 204 and may contain one or more programming instructions. Optionally, program instructions may be stored on a computer-readable storage medium, such as a magnetic disk, optical disk, recordable memory device, flash memory, or other physical storage medium. Computer instructions may also be communicated via a communications transmission, data stream, or a modulated carrier wave. In one example, program instructions implementing model generation engine 209, as described further in this description, may be stored on storage drive 212, hard drive 216, read only memory (ROM) 206, random access memory (RAM) 208, or may exist as a stand-alone service external to the stand-alone computer architecture.

Some or all of the process described in relation to model generation engine 209 may be performed under the control of one or more computer systems configured with specific computer-executable instructions and may be implemented as code (e.g., executable instructions, one or more computer programs or one or more applications) executing collectively on one or more processors, by hardware or combinations thereof. The code may be stored on a non-transitory computer-readable storage medium, for example, in the form of a computer program including a plurality of instructions executable by one or more processors. The computer-readable storage medium may be non-transitory.

Model generation engine 209 may include a number of modules. These modules may be software modules, hardware modules, or a combination thereof. If the modules are software modules, the modules can be embodied on a computer-readable medium and processed by a processor in any of the computer systems described herein. It should be noted that any module or data store described herein, may be, in some embodiments, a service responsible for managing data of the type required to make corresponding calculations. The modules may exist within the model generation engine 209 or may exist as separate modules or services external to the model generation engine 209. These modules are directed to performing operations by Model Generation Engine 209 to accelerate the LARS-LASSO algorithm for variable selection, with the overall goal of improving computational performance of CPU 204 during operations of predictive modeling. The performance of the proposed efficient LARS-LASSO algorithm has been evaluated on both synthetic and real data sets.

A disk controller 210 can interface with one or more optional disk drives to the bus 202. These disk drives may be external or internal floppy disk drives such as storage drive 212, external or internal CD-ROM, CD-R, CD-RW, or DVD drives 214, or external or internal hard drive 216. As indicated previously, these various disk drives and disk controllers are optional devices.

A display interface 218 may permit information from the bus 202 to be displayed on a display 220 in audio, graphic, or alphanumeric format. Communication with external devices may optionally occur using various communication ports 222. In addition to the standard computer-type components, the hardware may also include data input devices, such as a keyboard 224, or other input/output devices 226, such as a microphone, remote control, touchpad, keypad, stylus, motion, or gesture sensor, location sensor, still or video camera, pointer, mouse or joystick, which can obtain information from bus 202 via interface 228.

### LARS-LASSO Algorithm Example

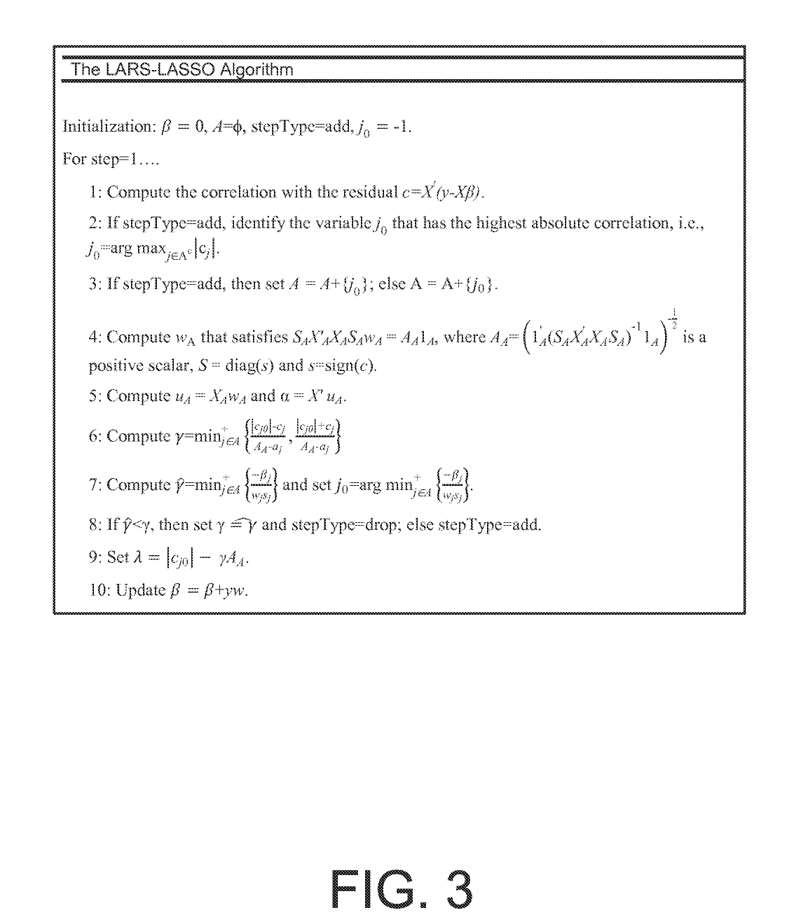

FIG. 3 illustrates an example of a process 300 for applying a LARS-LASSO algorithm to a data set. LASSO is a model selection algorithm that performs model selection by solving a penalized version of the ordinary least squares regression algorithm. In a LASSO algorithm, X denotes the data design matrix, and y denotes the corresponding response. A linear model can be used to fit the data as follows:

y=Xβ+∈

Here, β contains the model coefficients and ∈ represents the step size. LASSO estimates the model coefficients by solving the following penalized version of the ordinary least squares regression:

$${min}_{β} {‖ X β - y ‖}_{2}^{2} subject to {‖ β ‖}_{1} \leq t$$

or equivalently:

$${min}_{β} \frac{1}{2} {‖ X β - y ‖}_{2}^{2} + λ {‖ β ‖}_{1} ( Lasso Equation )$$

In this example, there is a one-to-one correspondence between the parameter t and λ, where t is a radius, and λ is a regularization parameter. λ determines the influence of the Lasso penalty. The larger the λ, the sparser the solution (e.g., the fewer variables included in the model). As t grows, so does the density of the solution, resulting in a model with an increasing number of variables. The constrained LASSO formulation is a linearly constrained quadratic programming problem. Similarly, the unconstrained formulation can be converted to an equivalent linearly constrained quadratic programming problem.

In FIG. 3, A denotes the set of variables that have entered into the model, and “stepType” indicates a drop or add operation. At each pass of LARS-LASSO, a variable is added into or dropped from the model. At line 1 of FIG. 3, a model generation engine (e.g., the model generation engine 209 of FIG. 2) computes the correlation between each variable and the residual y−Xβ. The model generation engine may then identify a variable j₀ that has the highest absolute correlation at line 2, where A^{c} denotes the set of variables that are not in the active set A. At line 3 of FIG. 3, variable j₀ may be added or dropped based on the stepType operation. A vector w_{A} may be computed at line 4 by solving a linear system. Here, the value in w has zero entries for those inactive variables, i.e., wⱼ=0, ∀j∉A. The model generation engine may then compute a vector called α at line 5, which depicts the change of the correlation when updating β in the direction of w. A step size may be computed based on the inactive variables at line 6. Here, min_{j∈A}_{^{c}}⁺ indicates that the minimum has taken over positive components within each choice of j in A^{c}. At line 7, a step size can be computed based on the active variables. At line 8, a stepType for the next operation may be determined. The regularization parameter λ may be updated at line 9. At line 10, the model generation engine may update the model coefficients β. Here, β provides the LASSO solution corresponding to the regularization parameter λ.

In practice, the LARS-LASSO is executed until some criterion is achieved (e.g., Schwarz Bayesian information criterion).

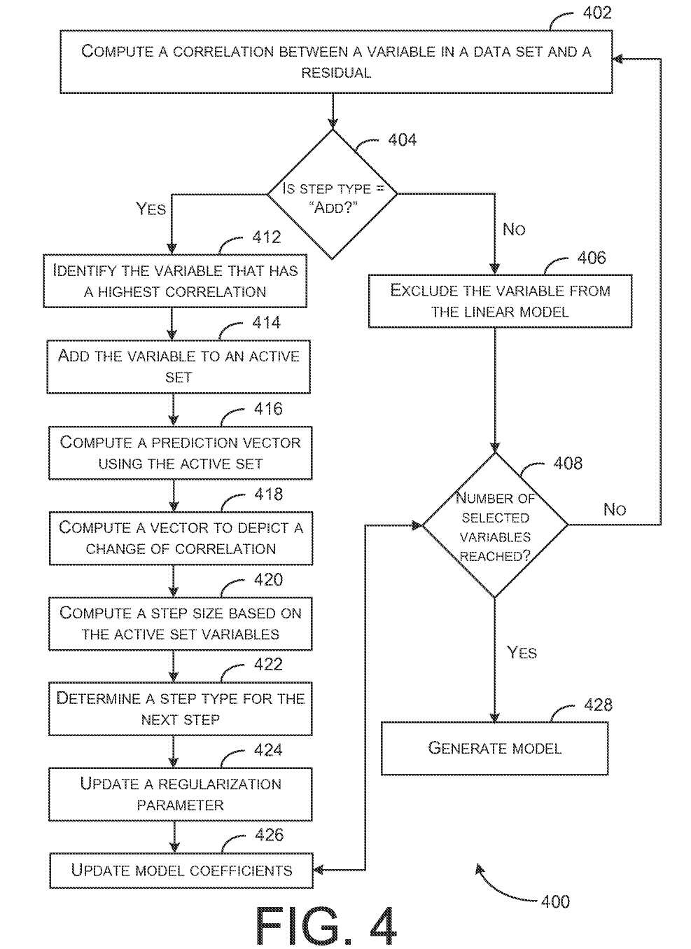

FIG. 4 illustrates an example of a flow diagram 400 for generating, by a model generation engine, a linear model for the data set using a LARS-LASSO algorithm. At the start of flow diagram 400, no variables exist in the model. The flow diagram 400 can be used to test the addition of each variable and add the variable of the set of variables that improves the model the most. The flow may begin at block 402, where a correlation between a variable of a data set and a residual can be computed. A residual is the difference between observed data of the response variable and the fitted values. A residual may be calculated by y−Xβ where y is the response variable, X denotes the data design matrix, and β contains the model coefficients.

At decision block 404, a determination is made regarding what operation type (e.g., add or drop) is being used. If the operation type indicates a “drop” intent, then the flow may proceed to block 406 where the variable can be excluded from the linear model. At decision block 408, if a number of selected variables has not been reached, the flow may proceed back to block 402.

If the step type indicates an “add” intent at decision block 404, the flow may proceed to block 412 where the variable that has the highest correlation to the residual is identified. Once identified, the variable may be added to the active set of variables at block 414. At block 416, a prediction vector is computed (e.g., by solving a linear system) using the active set of variables. A prediction vector may have zero entries for inactive variables.

At block 418, a vector a may be computed which depicts the change of the correlation when updating β in a particular direction. At block 420, a step size may be computed based on the inactive variables.

At block 422, a step size for the next step may be computed based on the active variables. At block 422, a step type for the next step is determined. A regularization parameter may be updated at block 424. At block 426, model coefficients may be updated. The flow may then proceed to decision block 408. If the number of selected variables has not been reached, the flow may proceed back to block 402. If the number of selection variables has been reached, then the flow may proceed to block 428 where the model may be generated.

### LARS-LASSO Algorithm Using SASVI

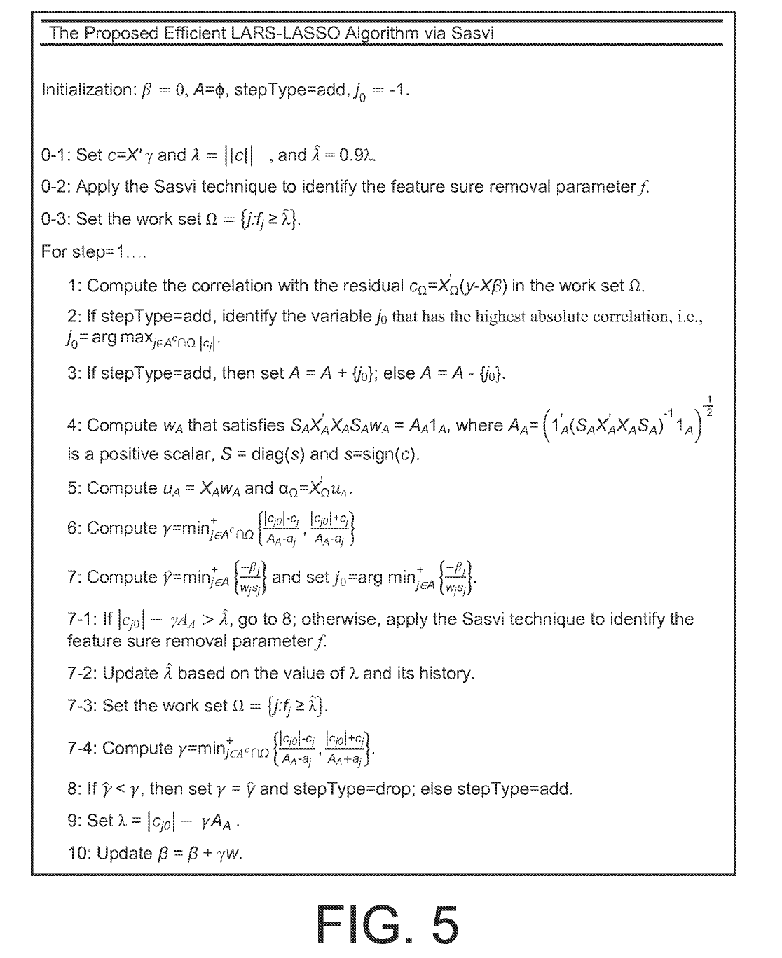

FIG. 5 illustrates an example of process 500 for applying a LARS-LASSO Algorithm to a reduced data set, the reduced data set determined using a SASVI safe screening technique.

An analysis on the LARS-LASSO algorithm referenced above reveals a function, c=X′(y−Xβ), for calculating the correlation between all the variables with the residual (line 1), and a function, α_{Ω}=X′u_{A}, for calculating the correlation between all the variables with the equiangular vector U_{A}=X_{A}w_{A} (line 5). Note that, 1) the computation of c and a can be expensive especially when the number of variables is large; and 2) the other lines are relatively cheap to compute as they either operate on the active set only or the computation naturally requires small effort. The LARS-LASSO algorithm using SASVI can reduce the computational cost for line 1 and line 5.

Specifically, the SASVI technique is applied to restrict the computation to a small set of variables in the active set of variables. Additionally, an effective scheme is developed for predicting the regularization parameter to be checked.

In FIG. 5, A denotes the set of variables that have entered into the model, and “stepType” indicates a drop or add intention. At each pass of LARS-LASSO, a variable is added into or dropped from the model. At line 0-1 of FIG. 5, a model generation engine (e.g., the model generation engine 209 of FIG. 2) initializes \hat{λ}, a variable used to denote the regularization parameter for safe screening. \hat{λ}, is initialized with a ratio of maximum absolute correlation between the variables and the response.

At line 0-2, the SASVI technique is applied to identify a feature sure removal parameter f associated with λ=∥c∥_{∞}. Specifically, given a solution β₁ at regularization parameter λ₁, variables are identified within the data set that are guaranteed to have zero coefficients in β₂ at λ₂. These identified variables may be excluded when computing β₂.

For example, SASVI is built upon an analysis of the following problem:

$${min}_{β} \{ - β b + \vert β \vert \} ( Equation for minimizing β )$$

### Consider the Following Equations:

If |b|≦1, then the minimum of the equation for minimizing β above is 0; (Eq. 1)

If |b|>1, then the minimum of the equation for minimizing β above is −∞; (Eq. 2) and

If |b|<1, then the optimal solution β*=0 (Eq. 3).

Let θ denote the optimized combination of the variables of the Lasso equation above. In light of Eq. 2, it can be shown that βⱼ*, the j-th component of the optimal solution to Eq. 1, optimizes:

$${min}_{β} \{ - {β}_{j} ( {x}_{j} , {θ}^{*} ) + \vert {β}_{j} \vert \}$$

where xⱼ denotes the j-th component of the optimal solution to Eq. 1 and θ* denotes the optimal dual variable of Eq. 1. It is required from the results to Eq. 2 that | [symbol] xⱼ,θ* [symbol] |<1 to ensure that Eq. 3 does not equal to −∞. Thus,

| [symbol] xⱼ,θ* [symbol] |<1 [symbol] βⱼ*=0 (Eq. 4)

Eq. 4 illustrates that the j-th feature can be safely eliminated in the computation of β* if | [symbol] xⱼ,θ* [symbol] |<1. Let λ₁ and λ₂ be two distinct regularization parameters that satisfy:

λₘₐₓ>λ₁>λ₂>0 (Eq. 5)

where λₘₐₓ denotes the value of λ above which the solution to Eq. 1 is zero. Let β₁* and β₂* be the optimal primal variables corresponding to λ₁ and λ₂, respectively. Let θ₁* and θ₂* be the optimal dual variables corresponding to λ₁ and λ₂, respectively.

The SASVI technique involves first deriving the dual problem of Eq. 1. Suppose that the primal and dual solutions β₁* and θ₁* for a given regularization parameter λ₁ have been obtained. Eq. 1 is solved with λ=λ₂ by using Eq. 4 to screen the features to save computational cost. But the dual optimal θ₂* has not been determined. A feasible set for θ₂* may be constructed for estimating an upper-bound of |<xⱼ, θ₂*>|. The variable xⱼ may safely be removed if this upper-bound is less than 1. The construction of a tight feasible set for θ₂* is one consideration in the SASVI screening technique. If the constructed feasible set is too loose, less variables may be removed.

At line 0-3, an active set Ω determined from line 0-2 is introduced to add only the variables that have a feature sure removal parameter over \hat{λ}.

At line 1, the correlation between each variable and the residual y−Xβ is computed. However, note that line 1 has now restricted the computation of c using the active set Ω, thus decreasing the computation cost compared to line 1 in FIG. 3. Model generation engine may then identify a variable j₀ that has the highest absolute correlation at line 2, where A^{c} denotes the set of variables that are not in the active set A. At line 3 of FIG. 3, variable j₀ may be added or dropped based on stepType. A vector w_{A} may be computed at line 4 by solving a linear system. Here, the value in w has zero entries for those inactive variables, i.e., wⱼ=0, ∀j∉A. The model generation engine may then compute a vector called a, which depicts the change of the correlation when updating β in the direction of w. A step size may be computed based on the inactive variables at line 6. Here, min_{j∈A}_{^{c}}⁺ indicates that the minimum is taken over by positive components within each choice of j in A^{c}. At line 7, a step size can be computed based on the active variables.

Lines 7-1, 7-2, 7-3, and 7-4 test whether the variable \hat{λ} is appropriate for safe screening. Specifically, if |cⱼ₀|−γA_{A}>\hat{λ}, \hat{λ} is appropriate for safe screening, then the algorithm goes to line 8. Otherwise, the flow proceeds to line 7-1 where the feature sure removal parameter associated with the currently used λ is recomputed. At line 7-2, \hat{λ} may be updated by setting it to a ratio of the currently used λ. In one example, a constant ratio may be used (e.g., 0.9). However, a constant ratio is not required. Another example of updating \hat{λ} may make use of the history of the regularization parameter λ, and set λ based on the ratio between the regularization parameter of the previous operation and the current operation. For example, if the ratio between the regularization parameter of the previous operation and the current operation is 0.95, \hat{λ}=0.95⁴λ, where the variable \hat{λ} is predicted to be appropriate for the following 4 operations. At line 7.3, the active set Ω is updated. At line 7-4, the step size γ is recomputed.

At line 8, a stepType for the next operation may be determined. The regularization parameter λ may be updated at line 9. At line 10, the model generation engine may update the model coefficients β. Here, β provides the LASSO solution corresponding to the regularization parameter λ.

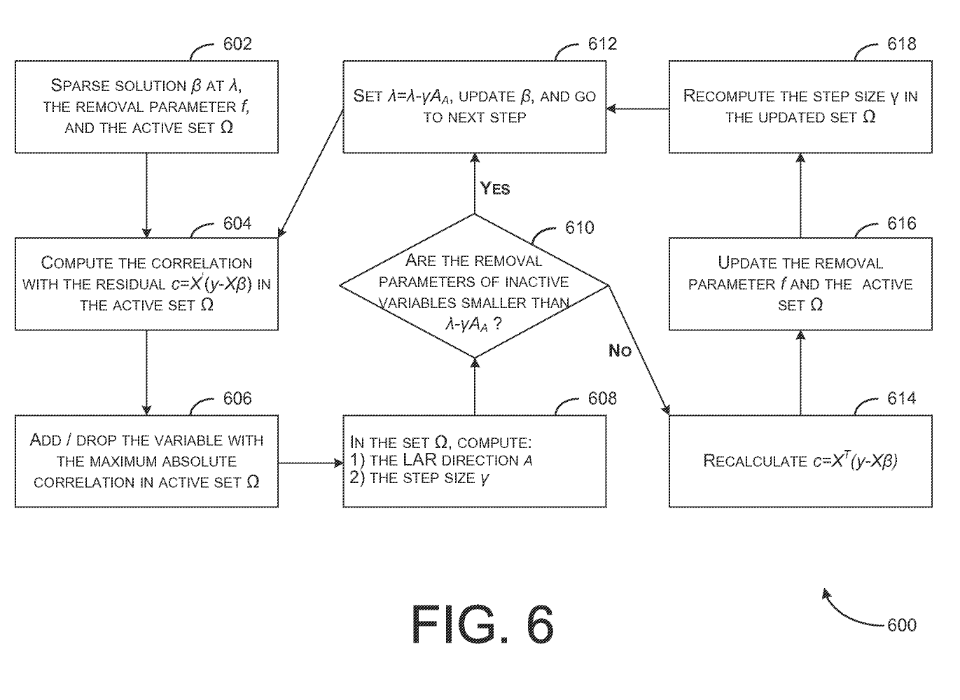

FIG. 6 illustrates another example of a flow diagram for generating one or more linear models for the data set. Set β is initialized with a zero vector. The flow may begin at block 602, where a sparse solution set β is determined at a given parameter λ, removal parameter f is computed, and active set Ω is computed.

At block 604, a correlation between the residual c_{Ω}=X_{Ω}′(y−Xβ) and the active set Ω is computed. At block 606, the variable with the maximum absolute correlation to the residual of the variables in the active set is added or dropped from the linear model as described above.

At block 608, a LAR direction a is computed (e.g., by executing lines 4-6 of FIG. 5) and the step size y is computed. At decision block 610, a determination regarding whether the removal parameters of the inactive variables are smaller than a threshold value (e.g., λ−yA_{A}). This determination may be accomplished by executing line 7-1 of FIG. 5.

If the removal parameter of the inactive variables are smaller than then threshold value, then the flow may proceed to block 612, where λ and β are updated (e.g., corresponding to lines, 8, 9, and 10 in FIG. 5).

If the removal parameter of the inactive variables are greater than then threshold value, then the flow may proceed to block 614, where the correlation c_{Ω}=X_{Ω}′(y−Xβ) is recalculated. At block 616, the removal parameter f is recomputed, as is the active set Ω (e.g., according to lines 7-1 to 7-3 of FIG. 5). At block 618, the step size γ is updated (e.g., according to line 7-4 of FIG. 5. The flow may then proceed to block 612, where λ and β are updated (e.g., corresponding to lines, 8, 9, and 10 in FIG. 5).

The flow may then proceed to block 604 and repeat blocks 604 through 618 until no more variables exist that improve the model.

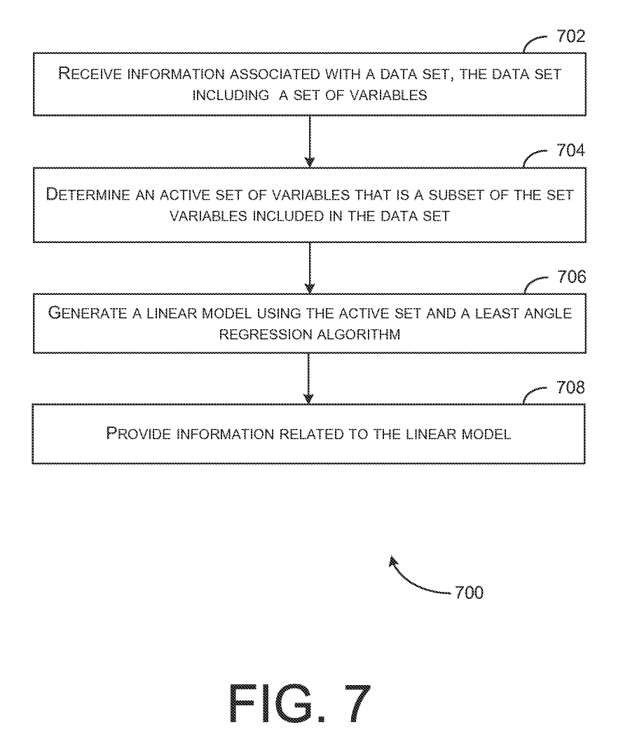

FIG. 7 illustrates an example of a flow diagram 700 for generating a linear model. The flow may begin at block 702, where information related to a data set is received. The data set may include a set of variables that may be related to a linear model for predicting a response variable of the data set.

At block 704, an active set of variables is determined using a safe screening algorithm, the active set being a subset of the variables included in the data set. Further, the active set may exclude variables from the data set that are determined to be below a threshold degree of relevance for predicting the response variable. The excluded variables may be redundant or irrelevant variables of the data set.

At block 706, a linear model may be generated using the active set and a least angle regression algorithm (e.g., LARS). The least angle regression algorithm may constrain a number of absolute regression coefficients utilized in the least angle regression algorithm.

At block 708, information related to the linear model may be provided to a user of the computer-program product. The information may be provided via a graphical interface or any suitable method of communicating such information.

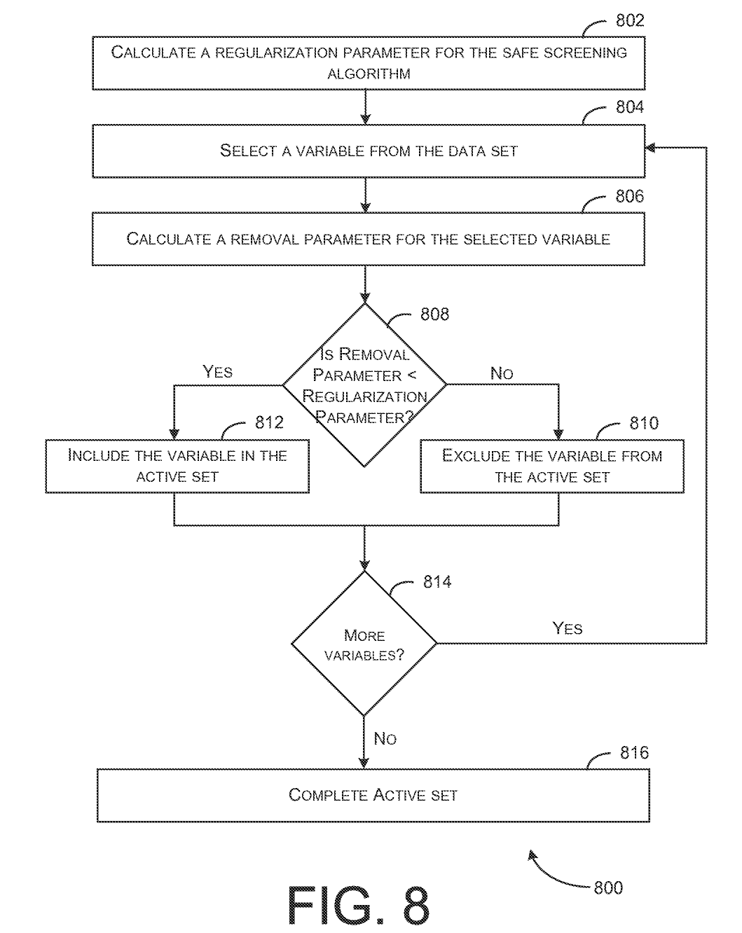

FIG. 8 illustrates a further example of a flow diagram 800 for determining an active set using a safe screening algorithm (e.g., SASVI). The flow may begin at 802, where a regularization parameter for a safe screening algorithm is calculated. At block 804, a variable is selected from the data set. A feature sure removal parameter may be calculated for the selected variable at block 806. At decision block 808, a determination may be made as to whether the removal parameter is less than the regularization parameter. If the removal pattern is not less than the regularization parameter, the variable may be excluded from the active set at block 810. However, if the removal pattern is less than the regularization parameter, the variable may be included in the active set at block 812. At decision block 814, a determination as to whether or not there are more variables in the data set that have not been selected is made. If there are more variables to select, the flow may proceed to block 804 and selection of another variable from the data set may be made. Blocks 804 to 814 may be repeated until a determination is made at block 814 that there are no more variables to select from the data set. At which point, the active set is complete at block 816.

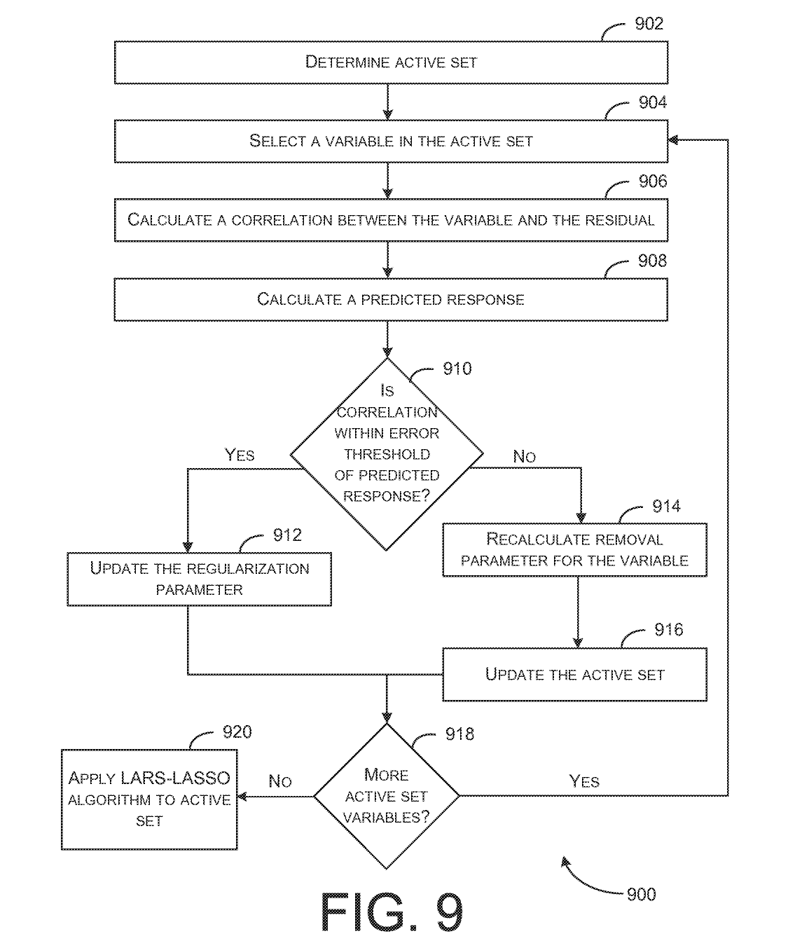

FIG. 9 illustrates an example of a flow diagram 900 for updating an active set for the data set. The flow may begin at block 902, where an active set may be determined (e.g., by the process described in FIG. 8). The flow may then proceed to block 904, where a variable in the active set may be selected. At block 906, a correlation between the variable and the residual may be calculated. At block 908, a predicted response to the variable may be calculated.

The flow may then proceed to decision block 910, where a determination as to whether or not the correlation is within an error threshold of a predicted response is made. If the correlation is within the error threshold, the flow may proceed to block 912 where the regularization parameter may be updated. If the correlation is not within the error threshold, the flow may proceed to block 914 where the removal parameter for the variable may be recalculated. The flow may then proceed to block 916, where the active set is updated.

Following blocks 912 or 916, the flow may proceed to decision block 918 where a determination as to whether or not there are more variables in the active set is determined. If more variables are included in the active set, then the flow may proceed back to 904, where a new variable is selected. Blocks 904 to 918 may be repeated for each variable in the active set. When no more variables exist in the active set, as determined by block 918, the flow may proceed to block 920 where a LARS-LASSO, or other model selection algorithm, may be applied to the active set of variables.

### Improvements on the LARS-LASSO Algorithm in Computing Operations

Methods discussed above are directed to accelerating the LARS-LASSO algorithm for variable selection, with the overall goal of improving computational performance for predictive modeling. The performance of the proposed efficient LARS-LASSO algorithm has been evaluated on both synthetic and real data sets.

### Synthetic Data

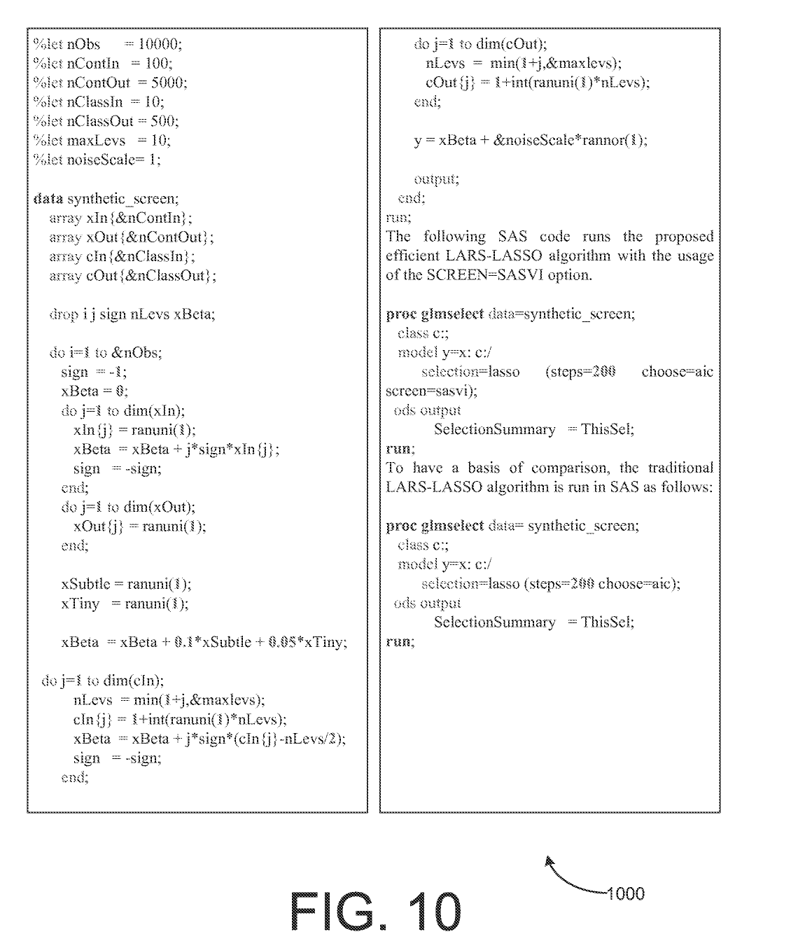

A synthetic data set may be is simulated where the response y depends systematically on a relatively small subset of a much larger set of regressors. Synthetic data contains 10,000 samples and slightly over 10,000 variables/parameters may be generated utilizing, for example, the algorithm of FIG. 10.

The solutions obtained with the proposed processes above are identical to the traditional LARS-LASSO algorithm, since the used screening method is safe. In terms of efficiency, it takes about 19.29 seconds (real time) and 47.26 seconds (cpu time) on a personal computer with 4 cores for the proposed algorithm to generate a model, while it takes 40.86 seconds (real time) and 123.27 seconds (cpu time) for the traditional LARS-LASSO algorithm to generate a model. The reported real (cpu) time includes reading data, running the LARS-LASSO algorithm, and generating the required tables/figures. The increased efficiency of the proposed algorithm over the traditional LARS-LASSO algorithm is even higher if one only considers the time on running the LARS-LASSO algorithm.

### Real Data

The elastic net approach is an extension of LASSO. It can be solved by the LARS-LASSO algorithm. To demonstrate the performance of the systems and methods discussed above, a microarray data set called the leukemia (LEU) data set may be used. The LEU data has been used to demonstrate the performance of the elastic net method in comparison with that of the LASSO algorithm. The LEU data set consists of 7,129 genes and 72 samples, and 38 samples are used as training samples. Among the 38 training samples, 27 are type 1 leukemia (acute lymphoblastic leukemia) and 11 are type 2 leukemia (acute myeloid leukemia). The goal is to construct a diagnostic rule based on the expression level of those 7,219 genes to predict the type of leukemia. The remaining 34 samples are used as the validation data for picking the appropriate model or as the test data for testing the performance of the selected model.

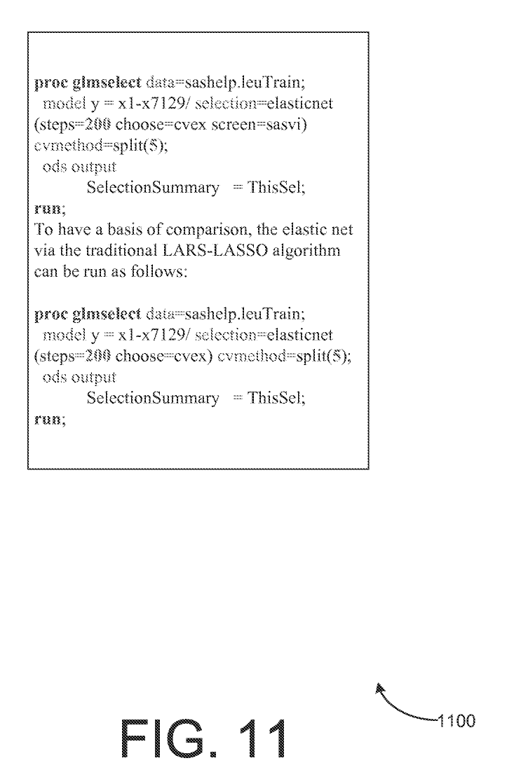

With the proposed innovation, a 5-fold external cross validation for the elastic net approach can be run as depicted in the code included in FIG. 11. Again, the solution obtained with the proposed innovation is identical to the one obtained the traditional LARS-LASSO algorithm. In terms of efficiency, it takes about 17.84 seconds (real time) and 28.34 seconds (cpu time) on a personal computer with 4 cores when the systems and methods discussed above are used to generate a linear model, while it takes 24.73 seconds (real time) and 49.32 seconds (cpu time) for the traditional LARS-LASSO algorithm to generate a linear model.

Systems and methods according to some examples may include data transmissions conveyed via networks (e.g., local area network, wide area network, Internet, or combinations thereof, etc.), fiber optic medium, carrier waves, wireless networks, etc. for communication with one or more data processing devices. The data transmissions can carry any or all of the data disclosed herein that is provided to, or from, a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, removable memory, flat files, temporary memory, databases, programming data structures, programming variables, IF-THEN (or similar type) statement constructs, etc.). It is noted that data structures may describe formats for use in organizing and storing data in databases, programs, memory, or other computer-readable media for use by a computer program.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows and figures described and shown in this specification can be performed by one or more programmable processors executing one or more computer programs to perform functions by operating on input data and generating output.

Generally, a computer can also include, or be operatively coupled to receive data from or transfer data to, or both, one or more mass storage devices for storing data (e.g., magnetic, magneto optical disks, or optical disks). However, a computer need not have such devices. Moreover, a computer can be embedded in another device, (e.g., a mobile telephone, a personal digital assistant (PDA), a tablet, a mobile viewing device, a mobile audio player, a Global Positioning System (GPS) receiver), to name just a few. Computer-readable media suitable for storing computer program instructions and data include all forms of nonvolatile memory, media and memory devices, including by way of example semiconductor memory devices (e.g., EPROM, EEPROM, and flash memory devices); magnetic disks (e.g., internal hard disks or removable disks; magneto optical disks; and CD ROM and DVD-ROM disks). The processor and the memory can be supplemented by, or incorporated in, special purpose logic circuitry.

The computer components, software modules, functions, data stores and data structures described herein may be connected directly or indirectly to each other in order to allow the flow of data needed for their operations. It is also noted that a module or processor includes, but is not limited to, a unit of code that performs a software operation, and can be implemented, for example, as a subroutine unit of code, or as a software function unit of code, or as an object (as in an object-oriented paradigm), or as an applet, or in a computer script language, or as another type of computer code. The software components or functionality may be located on a single computer or distributed across multiple computers depending upon the situation at hand.

The computer may include a programmable machine that performs high-speed processing of numbers, as well as of text, graphics, symbols, and sound. The computer can process, generate, or transform data. The computer includes a central processing unit that interprets and executes instructions; input devices, such as a keyboard, keypad, or a mouse, through which data and commands enter the computer; memory that enables the computer to store programs and data; and output devices, such as printers and display screens, that show the results after the computer has processed, generated, or transformed data.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products (i.e., one or more modules of computer program instructions encoded on a computer-readable medium for execution by, or to control the operation of, data processing apparatus). The computer-readable medium can be a machine-readable storage device, a machine-readable storage substrate, a memory device, a composition of matter effecting a machine-readable propagated, processed communication, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question (e.g., code that constitutes processor firmware, a protocol stack, a graphical system, a database management system, an operating system, or a combination of one or more of them).

While this disclosure may contain many specifics, these should not be construed as limitations on the scope of what may be claimed, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be utilized. Moreover, the separation of various system components in the implementations described above should not be understood as requiring such separation in all implementations, and it should be understood that the described program components and systems can generally be integrated together in a single software or hardware product or packaged into multiple software or hardware products.

Some systems may use Hadoop®, an open-source framework for storing and analyzing big data in a distributed computing environment. Some systems may use cloud computing, which can enable ubiquitous, convenient, on-demand network access to a shared pool of configurable computing resources (e.g., networks, servers, storage, applications and services) that can be rapidly provisioned and released with minimal management effort or service provider interaction. Some grid systems may be implemented as a multi-node Hadoop® cluster, as understood by a person of skill in the art. Apache™ Hadoop® is an open-source software framework for distributed computing. Some systems may use the SAS® LASR™ Analytic Server in order to deliver statistical modeling and machine learning capabilities in a highly interactive programming environment, which may enable multiple users to concurrently manage data, transform variables, perform exploratory analysis, build and compare models and score. Some systems may use SAS In-Memory Statistics for Hadoop® to read big data once and analyze it several times by persisting it in-memory for the entire session.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situations where only the disjunctive meaning may apply.

1. A computer-program product tangibly embodied in a non-transitory machine-readable storage medium, including instructions configured to be executed to cause a data processing apparatus to:
receive, from a user of the computer-program product, information associated with a data set, the data set including a set of variables, the set of variables being related to a linear model for predicting a response variable of the data set;
determine an active set of variables using a safe screening algorithm, the active set of variables being a subset of the set of variables included in the data set that are determined to be below a threshold degree of relevance for predicting the response variable;
generate the linear model using the active set and a least angle regression algorithm including a least squares regression algorithm, the least squares regression algorithm constraining a number of absolute regression coefficients utilized in the least angle regression algorithm; and
provide, to the user of the computer-program product, information related to the linear model.

2. The computer-program product of claim 1, wherein the linear model is a best-fit regression line for the data set, the best-fit regression line being calculated based on the set of variables and the response variable.

3. The computer-program product of claim 1, wherein the least angle regression algorithm is a LARS-LASSO algorithm, and wherein the instructions on the data processing apparatus are configured to reduce an execution time of the LARS-LASSO algorithm with safe screening techniques.

4. The computer-program product of claim 1, wherein the instructions that are configured to determine the active set using the safe screening algorithm are further configured to be executed to cause the data processing apparatus to:
identify inactive variables in the data set that are guaranteed to have zero coefficients; and
exclude the inactive variables from the active set.

5. The computer-program product of claim 1, wherein the instructions that are configured to determine the active set using the safe screening algorithm are further configured to be executed to cause the data processing apparatus to calculate a regularization parameter for the safe screening algorithm, the regularization parameter indicating an absolute correlation between the set of variables of the data set and the response variable.

6. The computer-program product of claim 5, wherein the regularization parameter for the safe screening algorithm is has not been calculated prior to determining the active set.

7. The computer-program product of claim 5, wherein the instructions that are configured to determine the active set using the safe screening algorithm are further configured to be executed to cause the data processing apparatus to, for each particular variable of the set of variables included in the data set:
calculate a removal parameter for the particular variable based on the particular variable to the response variable;
if the removal parameter is greater than the regularization parameter, include the particular variable in the active set; and
if the removal parameter is less than the regularization parameter, exclude the particular variable from the active set.

8. The computer-program product of claim 5, wherein the instructions are further configured to be executed to cause the data processing apparatus to:
calculate a residual for the data set, the residual estimating a statistical error for the data set;
for each variable in the active set:
calculate a correlation between the variable in the active set and the residual; and
calculate a equiangular vector based on the data set, the equiangular vector indicating a predicted response of the data set.

9. The computer-program product of claim 5, wherein the instructions are further configured to be executed to cause the data processing apparatus to:
determine whether the correlation is within an error threshold of the predicted response;
if the correlation is less than the error threshold, update the regularization parameter; and
if the correlation is greater than the error threshold:
calculate a removal parameter for the particular variable based on a correlation of the particular variable to the response variable; and
update the active set based on the calculated removal parameter.

10. A computer-implemented method comprising:
receiving, from a user of a computing device, a data set including a set of variables, the set of variables being related to a linear model for predicting a response variable of the data set;
determining, by the computing device, an active set of variables using a safe screening algorithm, the active set of variables being a subset of the set of variables included in the data set, the active set excluding variables from the data set that are determined to be below a threshold degree of relevance for predicting the response variable;
generating, by the computing device, the linear model using the active set and a least angle regression algorithm, the least angle regression including a least squares regression algorithm, the least squares regression algorithm constraining a number of absolute regression coefficients utilized in the least angle regression algorithm; and
providing, to the user of the computing device, information related to the linear model.

11.-19. (canceled)

20. A system, comprising:
a processor, and
a non-transitory computer-readable storage medium including instructions configured to be executed that, when executed by the processor, cause the system to perform operations including:
receiving, from a user of the system, a data set including a set of variables, the set of variables being related to a linear model for predicting a response variable of the data set;
determining an active set of variables using a safe screening algorithm, the active set of variables being a subset of the set of variables included in the data set, the active set excluding variables from the data set that are determined to be below a threshold degree of relevance for predicting the response variable; and
generating the linear model using the active set and a least angle regression algorithm, the least angle regression including a least squares regression algorithm, the least squares regression algorithm constraining a number of absolute regression coefficients utilized in the least angle regression algorithm; and
providing, to the user of the system, information related to the linear model.

21. The system of claim 20, wherein the electronic linear model is a best-fit regression line for the data set, the best-fit regression line being calculated based on the set of variables and the response variable.

22. The system of claim 20, wherein the least angle regression algorithm is a LARS-LASSO algorithm, and wherein the instructions on the system are configured to reduce an execution time of the LARS-LASSO algorithm with safe screening techniques.

23. The system of claim 20, wherein the safe screening algorithm causes removal of variables from the data set that are determined to be substantially irrelevant for predicting the response variable.

24. The system of claim 20, wherein the instructions that are, when executed by the processor, configured to determine the active set using the safe screening algorithm include further instructions that are configured to, when executed by the processor, cause the system to perform operations including:
identifying inactive variables in the data set that are guaranteed to have zero coefficients; and
excluding the inactive variables from the active set.

25. The system of claim 20, wherein the instructions that are, when executed by the processor, configured to determine the active set using the safe screening algorithm include further instructions that are configured to, when executed by the processor, cause the system to perform operations including calculating a regularization parameter for the safe screening algorithm, the regularization parameter indicating an absolute correlation between the set of variables of the data set and the response variable.

26. The system of claim 25, wherein the regularization parameter for the safe screening algorithm has not been calculated prior to determining the active set.

27. The system of claim 25, wherein the instructions that are, when executed by the processor, configured to determine the active set using the safe screening algorithm further comprises, include further instructions that are configured to, when executed by the processor, cause the system to perform operations for each particular variable of the set of variables included in the data set, the operations including:
calculating a removal parameter for the particular variable based on the particular variable to the response variable;
including the particular variable in the active set when the removal parameter is greater than the regularization parameter; and
excluding the particular variable from the active set when the removal parameter is less than the regularization parameter.

28. The system of claim 25, including further instructions configured to be executed that, when executed by the processor, cause the system to perform further operations including:
calculating a residual for the data set, the residual estimating a statistical error for the data set; and
for each variable in the active set:
calculating a correlation between the variable in the active set and the residual; and
calculating a equiangular vector based on the data set, the equiangular vector indicating a predicted response of the data set.

29. The system of claim 27, including further instructions configured to be executed that, when executed by the processor, cause the system to perform further operations including:
determining whether the correlation is within an error threshold of the predicted response;
updating the regularization parameter when the correlation is less than the error threshold; and
if the correlation is greater than the error threshold:
calculating a removal parameter for the particular variable based on a correlation of the particular variable to the response variable; and
updating the active set based on the recalculated removal parameter.
